(19) United States
(12) Patent Application Publication
(10) Pub. No.: US 2010/0274028 A1
(43) Pub. Date: Oct. 28, 2010

(54) REMOVAL OF POLAR ORGANIC COMPOUNDS AND EXTRANEOUS METALS FROM ORGANOSILANES

(75) Inventors: Ekkehard Mueh, Rheinfelden (DE); Hartwig Rauleder, Rheinfelden (DE); Helmut Mack, Traunstein (DE); Jaroslaw Monkiewicz, Rheinfelden (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/681,114

(22) PCT Filed: Aug. 19, 2008
(86) PCT No.: PCT/EP08/60826

§ 371 Date: Apr. 1, 2010

(30) Foreign Application Priority Data
Oct. 12, 2007 (DE) 102007048937.6

(51) Int. Cl. C07F 7/20; C07F 7/18

(52) U.S. Cl. 549/215; 556/414; 556/417; 556/421; 556/413; 556/429; 556/436; 556/445; 556/466; 556/465

(57) ABSTRACT

The invention relates to a process for treating a composition comprising organosilanes and at least one polar organic compound and/or at least one extraneous metal and/or a compound containing extraneous metal, wherein the composition is contacted with at least one adsorbent and a composition in which the content of the organic polar compound and/or of the extraneous metal and/or of the compound containing extraneous metal is reduced is subsequently obtained, and also to a corresponding composition in which the content of polar organic compounds and/or extraneous metals has been reduced to traces, and to the use of organic resins, activated carbons, silicates and/or zeolites for reducing the amounts of the compounds mentioned.

The invention relates to a process for treating a composition comprising organosilanes and at least one polar organic compound and/or at least one extraneous metal and/or a compound containing extraneous metal, wherein the composition is contacted with at least one adsorbent and a composition in which the content of the organic polar compound and/or of the extraneous metal and/or of the compound containing extraneous metal is reduced is subsequently obtained, and also to a corresponding composition in which the content of polar organic compounds and/or extraneous metals has been reduced to traces, and to the use of adsorbents for reducing the amounts of the compounds mentioned.

Specifically in the case of use of organic silanes, such as alkoxysilanes, alkylalkoxysilanes, alkenyl-alkoxysilanes, alkynylalkoxysilanes, arylalkoxysilanes or else organofunctional silanes and salicylic esters, in nanotechnology or in the field of microelectronics, there is a need for ultrahigh-purity silanes in which the usual impurities have been reduced down to traces in the region of the detection limit. This is because even small amounts of impurities here have a considerable influence on the quality of the products produced using the silane. When silicon compounds are used in microelectronics, for example in the deposition of insulating dielectric layers in the semiconductor industry, even traces of contamination with polar organic compounds and/or extraneous metals generate considerable problems in these sensitive applications. The organic compounds mentioned are additionally disruptive in the production of these layers via CVD or spin-on processes and exert a negative effect on the layer morphology. When extraneous metals are present in the silicon compounds, this leads to undesired doping effects and lowers the lifetime of electrical components as a result of migration processes.

For process-related reasons, the industrial scale preparation of organic silanes results in contamination with undesired extraneous metals.

Frequently, in the preparation of organic silanes, polar organic impurities, for example alcohols, remain in the product after esterifications and cannot be removed by means of customary distillation steps.

EP 0 684 245 A2 discloses reducing the content of hydrocarbons in halosilanes by adsorbing them on an adsorbent, and EP 0 957 105 A2 discloses reduction of residual halogen contents and colour number improvement in alkoxysilane or alkoxysilane-based compositions by a treatment thereof with activated carbon.

It was an object of the invention to enable a process for reduction of the amounts of polar organic compounds and/or of the extraneous metal content, and also of the content of a compound containing extraneous metal, in organosilanes in a simple and economically viable manner. It was a further object to provide ultrahigh-purity organosilanes with ultra low contents of polar organic compounds and/or extraneous metals and compounds containing extraneous metal.

These objects are achieved according to the information in the claims.

It has been found that treatment of a composition comprising organosilanes, polar organic compounds, extraneous metals and/or compounds containing extraneous metal with an adsorbent by contacting them and then obtaining the composition considerably reduces the content of the organic polar compound, of the extraneous metals and/or of the compounds containing extraneous metal, especially when the composition is essentially anhydrous before the treatment.

The invention therefore provides a process for treating a composition comprising organosilanes and at least one polar organic compound and/or at least one extraneous metal and/or a compound containing extraneous metal, wherein the composition, which is especially essentially anhydrous, is contacted with at least one adsorbent and a composition in which the content of the organic polar compound and/or of the extraneous metal and/or of the compound containing extraneous metal is reduced is obtained.

In this context, it is especially advantageous that the extraneous metal content and/or the content of the compound containing extraneous metal—it is generally a residual content of extraneous metal or compound containing extraneous metal which is difficult to remove by distillation or cannot be removed any further—can be reduced, more particularly independently of one another, in each case to a content in the range of below 100 μg/kg, especially below 30 μg/kg, preferably below 15 μg/kg, more preferably below 10 μg/kg. Accordingly, it is preferred when the content of the polar organic compound, which is preferably present in the composition only in a low concentration, for example between 0.1 and 0.015% by weight, can be lowered down to traces of below 0.01% by weight.

In the context of the invention, polar organic compounds are considered to be organic compounds with a permanent dipole which are based on a carbon skeleton and more particularly do not contain a silicon atom. Preferred polar organic compounds are the alcohols used in the preparation of alkoxysilanes and/or those released in the hydrolysis and condensation of alkoxysilanes, for example methanol, ethanol, propanol and butanol, but also customary organic solvents which are used in the synthesis of the organosilanes; more particularly, the amounts of these polar organic compounds cannot be reduced any further by the customary methods which are familiar to those skilled in the art.

Organosilanes are considered especially to be organosilanes of the general formula I. In the composition to be treated, at least one organosilane which corresponds to the general formula I is present

R¹ₐR²_{b}R³_{c}Si(OR⁴)_{(4-a-b-c)} (I)

were 0≦a≦3, 0≦b≦3, 0≦c≦3 and a+b+c≦3, R¹ is hydrogen, a linear, branched and/or cyclic, optionally substituted alkyl group having 1 to 18 carbon atoms and/or a linear, branched and/or cyclic alkoxy, alkoxyalkyl, aryloxyalkyl, arylalkyl, aminoalkyl, haloalkyl, polyether, polyetheralkyl, alkenyl, alkynyl, epoxyalkyl, ureidoalkyl, mercaptoalkyl, cyanoalkyl, isocyanatoalkyl, methacryloyloxyalkyl and/or acryloyloxyalkyl group having 1 to 18 carbon atoms and/or an aryl group having 6 to 12 carbon atoms, where R² is hydrogen, a linear, branched and/or cyclic alkyl group having 1 to 18 carbon atoms and/or an aryl group having 6 to 12 carbon atoms, R³ is hydrogen, a linear, branched and/or cyclic alkyl group having 1 to 18 carbon atoms and/or an aryl group having 6 to 12 carbon atoms, and/or R⁴ is a linear, branched and/or cyclic alkyl and/or alkoxyalkyl group having 1 to 8 carbon atoms, and/or mixtures of these organosilanes.

Inventive organosilanes are especially tetraalkoxy silanes, alkyltrialkoxysilanes and/or dialkyldialkoxy-silanes, trialkylalkoxysilanes such as tetraethoxy-silane, tetramethoxysilane, methyltriethoxysilane, methyltrimethoxysilane, dimethyldiethoxysilane, dimethyldimethoxysilane, trimethylmethoxysilane and/or trimethylethoxysilane.

In the preferred embodiments, the aminoalkyl group for R¹ is preferably selected from the aminopropyl-functional groups of the formulae —(CH₂)₃—NH₂, —(CH₂)₃—NHR′, —(CH₂)₃—NH(CH₂)₂—NH₂ or —(CH₂)₃—NH(CH₂)₂—NH(CH₂)₂—NH₂, in which R′ is a linear, branched or cyclic alkyl group having 1 to 18 carbon atoms or an aryl group having 6 to 12 carbon atoms, the polyether group or polyetheralkyl group corresponds preferably to one of the formulae R′—(O—CH₂—CH₂—)ₙO—(CH₂)₃—, R′—(O—CH₂—CH₂—CH₂—)ₙO—(CH₂)₃—, R′—(O—CH₂—CH₂—CH₂—CH₂—)ₙO—(CH₂)₃—, R′—(O—CH₂—CH₂—)ₙO—, R′—(O—CH₂—CH₂—CH₂—)ₙO—, R′—(O—CH₂—CH₂—CH₂—CH₂—)ₙO—, R′o[—CH₂—CH(CH₃)—O]ₙ—(CH₂)₃— or R′O[—CH₂—CH(CH₃)—O]ₙ— with a chain length n of 1 to 30, especially 1 to 14, where R′ is preferably H or a linear, branched or cyclic alkyl group having 1 to 6 carbon atoms, especially methyl, ethyl, i-propyl or n-propyl, the methacryloyloxy- or acryloyloxyalkyl groups correspond preferably to a 3-methacryloyloxypropyl group and/or to a 3-acryloyloxypropyl group, the alkoxy group is preferably selected from the group of methoxy, ethoxy, n-propoxy and/or isopropoxy group, the alkenyl group is preferably a vinyl, isoprenyl or allyl group, the epoxy group corresponds preferably to a 3-glycidyloxypropyl or 2-(3,4-epoxycyclohexyl)ethyl group, the haloalkyl group corresponds preferably to a fluoroalkyl group with a R⁸*—Yₘ—, —(CH₂)ₛ— radical where R⁸* corresponds to a mono-, oligo- or perfluorinated alkyl radical having 1 to 9 carbon atoms or to a mono-, oligo- or perfluorinated aryl radical, where Y is also a CH₂, O, aryl or S radical, an m=0 or 1 and s=0 or 2. In one embodiment, R¹ corresponds to a F₃C(CF₂)ᵣ(CH₂)ₛ group where r is an integer of 0 to 9, s is 0 or 2, r is preferably 5 and s is preferably 2; particularly preferred groups are the CF₃(CF₂)₅(CH₂)₂— or CF₃(CF₂)₇(CH₂)₂— or CF₃(C₆H₄)— or C₆F₅ groups.

In the preferred embodiment, R² and/or R³ correspond to hydrogen or to a linear or branched alkyl group having to 8 carbon atoms, especially to a methyl, ethyl, n-propyl, isopropyl or n-octyl group, or to an aryl group having 6 carbon atoms, and R⁴ to a methyl, ethyl, n-propyl or isopropyl group, preference being given overall to tetraalkoxy-, trialkoxy- and/or dialkoxy-substituted silanes.

According to the invention, the compositions are additionally essentially anhydrous. An inventive composition is considered to be anhydrous when the Karl Fischer content of water is <10 ppm, especially <5 ppm.

In a further preferred embodiment, the composition to be treated comprises organosilanes which correspond to oligomeric or polymeric organosiloxanes which are obtained from the at least partial hydrolysis and condensation of organosilanes of the general formula I

R¹ₐR²_{b}R³_{c}Si(OR⁴)_{(4-a-b-c)} (I)

were 0≦a≦3, 0≦b≦3, 0≦c≦3 and a+b+c≦3, R¹ is hydrogen, a linear, branched and/or cyclic, optionally substituted alkyl group having 1 to 18 carbon atoms and/or a linear, branched and/or cyclic alkoxy, alkoxyalkyl, aryloxyalkyl, arylalkyl, aminoalkyl, haloalkyl, polyether, polyetheralkyl, alkenyl, alkynyl, epoxyalkyl, ureidoalkyl, mercaptoalkyl, cyanoalkyl, isocyanatoalkyl, methacryloyloxyalkyl and/or acryloyloxyalkyl group having 1 to 18 carbon atoms and/or an aryl group having 6 to 12 carbon atoms, where R² is hydrogen, a linear, branched and/or cyclic alkyl group having 1 to 18 carbon atoms and/or an aryl group having 6 to 12 carbon atoms, R³ is hydrogen, a linear, branched and/or cyclic alkyl group having 1 to 18 carbon atoms and/or an aryl group having 6 to 12 carbon atoms, and/or R⁴ is a linear, branched and/or cyclic alkyl and/or alkoxyalkyl group having 1 to 8 carbon atoms, and/or mixtures of these organosilanes. Oligomeric organosiloxanes are considered to be all siloxanes having at least two silicon atoms per siloxane unit.

Particular preference is given to the following substitution patterns for R¹, R², R³ and R⁴. In the preferred embodiments, the aminoalkyl group for R¹ is selected from the aminopropyl-functional groups of the formulae —(CH₂)₃—NH₂, —(CH₂)₃—NHR′, —(CH₂)₃—NH(CH₂)₂—NH₂ or —(CH₂)₃—NH(CH₂)₂—NH(CH₂)₂—NH₂, in which R′ is a linear, branched or cyclic alkyl group having 1 to 18 carbon atoms or an aryl group having 6 to 12 carbon atoms, the polyether group or polyetheralkyl group corresponds preferably to one of the formulae R′—(O—CH₂—CH₂—)ₙO —(CH₂)₃—, R′—(O—CH₂—CH₂—CH₂—)ₙO—(CH₂)₃—, R′—(O—CH₂—CH₂—CH₂—CH₂—)ₙO—(CH₂)₃—, R′—(O—CH₂—CH₂—)ₙO—, R′—(O—CH₂—CH₂—CH₂—CH₂—)ₙO—, R′O[—CH₂—CH(CH₃)—O]ₙ—(CH₂)₃— or R′O[—CH₂—CH(CH₃)—O]ₙ— with a chain length n of 1 to 30, especially 1 to 14, where R′ is preferably H or a linear, branched or cyclic alkyl group having 1 to 6 carbon atoms, especially methyl, ethyl, i-propyl or n-propyl, the methacryloyloxy- or acryloyloxyalkyl groups correspond preferably to a 3-methacryloyloxypropyl group and/or to a 3-acryloyloxypropyl group, the alkoxy group is preferably selected from the groups of methoxy, ethoxy, n-propoxy and/or isopropoxy, the alkenyl group is preferably a vinyl, isoprenyl or allyl group, the epoxy group corresponds preferably to a 3-glycidyloxypropyl or 2-(3,4-epoxycyclohexyl)ethyl group, the haloalkyl group corresponds preferably to a fluoroalkyl group with a R⁸*—Yₘ—(CH₂)ₛ— radical where R⁸* corresponds to a mono-, oligo- or perfluorinated alkyl radical having 1 to 9 carbon atoms or to a mono-, oligo- or perfluorinated aryl radical, where Y is also a CH₂, O, aryl or S radical, and m=0 or 1 and s=0 or 2. In one embodiment, R¹ corresponds to a F₃C(CF₂)ᵣ(CH₂)ₛ group where r is an integer of 0 to 9, s is 0 or 2, r is preferably 5 and s is preferably 2; particularly preferred groups are the CF₃(CF₂)₅(CH₂)₂— or CF₃(CF₂)₇(CH₂)₂— or CF₃(C₆H₄)— or C₆F₅ groups.

The oligomeric or polymeric organosiloxanes comprise especially catenated, cyclic, crosslinked and/or three-dimensionally crosslinked structural elements, where the catenated and cyclic structural elements, in idealized form, corresponds to the general formulae II and III

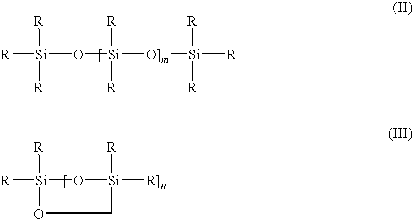

and where, in the crosslinked and/or three-dimensionally crosslinked structural elements—which have not been shown in idealized form—the substituents R, and also the substituents R of the structural elements of the formula II and/or III shown in idealized form, independently consist of the organic radicals R¹, R² and/or R³ and/or of hydroxyl groups. In general, the degree of oligomerization may be in the range of 2 to 30, but the degree of oligomerization or polymerization may also be higher. The degree of oligomerization or polymerization of the organosilanes corresponds to the number of Si units per molecule.

The composition of each oligomeric or polymeric organosilane is determined taking account of the fact that each oxygen atom of a monomeric silane unit of the general formula (I) can function as a bridge former between two silicon atoms. The number of possible available oxygen atoms of each silane of the general formula (I) thus also determines the functionality of each individual siloxane unit in the organosilane; the monomeric organosilanes of the general formula (I) may thus be present in mono-, di-, tri- or tetrafunctional form.

The structural units present for the formation of oligomeric and/or polymeric organosilanes with catenated, cyclic, crosslinked and/or three-dimensionally crosslinked structural elements accordingly include the monofunctional (R)₃—Si—O—denoted by M, the difunctional —O—Si(R)₂—O— denoted by D, the trifunctional (—O—)₃SiR to which the symbol T has been assigned, and the tetrafunctional Si(—O—)₄ with the symbol Q. The structural units are denoted according to their functionality by the symbols M, D, T and Q.

Extraneous metals and/or compounds containing extraneous metal are considered to be those in which the metal does not correspond to silicon. The at least one extraneous metal and/or compound containing at least one extraneous metal is/are adsorbed, more particularly selectively, from the composition containing organosilanes; the adsorption can be effected either in solution or in the gas phase. Extraneous metals or compounds containing extraneous metal are also understood to mean semimetals or compounds containing semimetals, for example boron, boron trichloride and boric esters, such as B(OMe)₃ or B(OEt)₃.

For example, the extraneous metals and/or compounds containing extraneous metal whose amounts are to be reduced may be metal halides, metal hydrogen halides, metal alkoxides, metallic esters and/or metal hydrides, and also mixtures of these compounds. However, it is also possible to remove the metal halides, metal hydrogen halides or metal hydrides functionalized with organic radicals, such as alkyl or aryl groups, from organosilanes with very good results. It is equally possible, for example, for particulate metals entrained within continuous processes to contaminate the composition. The contents of boron, aluminium, potassium, lithium, sodium, magnesium, calcium and/or iron can preferably be reduced; more particularly, compounds based on these metals are removed.

The process according to the invention is suitable particularly for the removal or reduction of the amounts of polar organic compounds and/or compounds containing extraneous metal whose boiling point is in the region of the boiling point of an organosilane or would be distilled over with it as an azeotrope. These polar organic compounds and/or compounds containing extraneous metal can be removed by distillation only with difficulty, if at all. A boiling point which is in the region of the boiling point of an organosilane is considered to be a boiling point which is in the range of the boiling point of one of the organosilanes at standard pressure (about 1013.25 hPa or 1013.25 mbar)±20° C.

In general, the amounts of the extraneous metal and/or compound containing extraneous metal can be reduced by 40.0 to 99.8% by weight. More particularly, the extraneous metal content is reduced by 50 to 90% by weight, preferably by 85 to 95% by weight, more preferably by 95 to 99.8% by weight. For iron-containing compositions, the process enables a reduction in the residual content by 85 to 95% by weight, more preferably by 90 to 99.8% by weight. In general, it is possible, for example, to reduce the aluminium content of a composition of inorganic silanes by 40 to 99% by weight, preferably by 85 to 99% by weight, and to reduce the boron content by 95 to 99.8% by weight.

The extraneous metal content and/or the content of compound containing extraneous metal in a composition can preferably be reduced in relation to the metallic compound, more particularly independently of one another, in each case to a content in the range of below 100 μg/kg. In the context of the invention, this composition is considered to be of ultrahigh purity. More particularly, the content can be reduced to below 30 μg/kg, preferably below 15 μg/kg, more preferably below 10 μg/kg.

Polar organic compounds in the context of the invention are considered to be organic compounds with a permanent dipole which are based on a carbon skeleton; these are more particularly alcohols such as ethanol, methanol, butanol, n-propanol and/or isopropanol. According to the invention, these polar organic compounds can be lowered to a content of below 0.01% by weight. A composition with a corresponding content of a polar organic compound is likewise considered to be of ultrahigh purity.

To perform the process, it is appropriately possible to use either inorganic or organic adsorbents, which may additionally be hydrophilic and/or hydrophobic. According to which polar organic compound and/or extraneous metals or compounds containing extraneous metal are to be removed, it may be appropriate that a mixture of hydrophilic and hydrophobic adsorbents or else one adsorbent which has both functions is used. The adsorbents may be selected from the group of the activated carbons or the silicates, especially from kieselguhr or siliceous earth; also suitable are zeolites, organic resins or silicates, such as fumed silica and precipitated silica (silica gel). Preferred adsorbents are activated carbon, especially Norit SA+activated carbon (Norit Deutschland GmbH), Seitz Super kieselguhr (Pall Corporation), kieselguhr (diameter 0.2-0.5 mm, Süd-Chemie).

In general, the inventive treatment of compositions comprising organosilanes is carried out in such a way that the adsorbent is first heated in order to carefully dry it and in order to remove any adsorbed volatile impurities and to enable maximum loading of the adsorbent. Subsequently, the dried absorbent is contacted under a protective gas atmosphere with the composition; it is optionally stirred. The treatment is suitably effected at room temperature and standard pressure over several hours. The composition is advantageously contacted with the adsorbent for 1 minute up to 10 hours, especially 2 minutes to 5 hours. The purified composition is obtained or removed generally by filtration, centrifugation or sedimentation. The process can be conducted batchwise or continuously as required. The resulting composition, based on organosilanes, has an extraneous metal content and/or content of compound containing extraneous metal reduced by 40 to 99.8% by weight. Expressed in μg/kg, the content can be reduced to below 100 μg/kg, especially below 30 μg/kg, preferably below 15 μg/kg, more preferably below 10 μg/kg. The content of the polar organic compounds can be lowered by this process to a content of below 0.01% by weight.

The invention also provides a composition, especially an ultrahigh-purity composition, containing at least one organosilane of the general formula I and/or organosilanes which correspond to oligomeric or polymeric organosiloxanes which are obtained from the at least partial hydrolysis and condensation of organosilanes of the general formula I

R¹ₐR²_{b}R³_{c}Si(OR⁴)_{(4-a-b-c)} (I)

were 0≦a≦3, 0≦b≦3, 0≦c≦3 and a+b+c≦3, R¹ is hydrogen, a linear, branched and/or cyclic, optionally substituted alkyl group having 1 to 18 carbon atoms and/or a linear, branched and/or cyclic alkoxy, alkoxyalkyl, aryloxyalkyl, arylalkyl, aminoalkyl, haloalkyl, polyether, polyetheralkyl, alkenyl, alkynyl, epoxyalkyl, ureidoalkyl, mercaptoalkyl, cyanoalkyl, isocyanatoalkyl, methacryloyloxyalkyl and/or acryloyloxyalkyl group having 1 to 18 carbon atoms and/or an aryl group having 6 to 12 carbon atoms, where R² is hydrogen, a linear, branched and/or cyclic alkyl group having 1 to 18 carbon atoms and/or an aryl group having 6 to 12 carbon atoms, R³ is hydrogen, a linear, branched and/or cyclic alkyl group having 1 to 18 carbon atoms and/or an aryl group having 6 to 12 carbon atoms, and/or R⁴ is a linear, branched and/or cyclic alkyl and/or alkoxyalkyl group having 1 to 8 carbon atoms, and/or mixtures of these organosilanes, whose extraneous metal content and/or content of the compound containing extraneous metal is in each case below 100 μg/kg and/or whose residual content of organic polar compounds is below 0.01% by weight. According to the invention, the polar organic compound is an alcohol, especially methanol, ethanol, n-propanol and/or isopropanol. The extraneous metal content and/or the content of the compound containing extraneous metal is preferably below 30 μg/kg, especially below 15 μg/kg and more preferably below 10 μg/kg. In addition, the inventive composition is essentially anhydrous.

Particular preference is given to the following substitution patterns for R¹, R², R³ and R⁴. In the preferred embodiments, the aminoalkyl group for R¹ is preferably selected from the aminopropyl-functional groups of the formulae —(CH₂)₃—NH₂, —(CH₂)₃—NHR′, —(CH₂)₃—NH(CH₂)₂—NH₂ or —(CH₂)₃—NH(CH₂)₂—NH(CH₂)₂—NH₂, in which R′ is a linear, branched or cyclic alkyl group having 1 to 18 carbon atoms or an aryl group having 6 to 12 carbon atoms, the polyether group or polyetheralkyl group corresponds preferably to one of the formulae R′—(O—CH₂—CH₂—)ₙO—(CH₂)₃—, R′—(O—CH₂—CH₂—CH₂—)ₙO—(CH₂)₃—, R′—(O—CH₂—CH₂—CH₂—CH₂—)ₙO—(CH₂)₃—, R′—(O—CH₂—CH₂—)ₙO—, R′—(O—CH₂—CH₂—CH₂—)ₙO—, R′—(O—CH₂—CH₂—CH₂—CH₂)ₙO—, R′ O[—CH₂—CH(CH₃)—O]ₙ—(CH₂)₃— or R′O[—CH₂—CH(CH₃)—O]ₙ— with a chain length n of 1 to 30, especially 1 to 14, where R′ is preferably H or a linear, branched or cyclic alkyl group having 1 to 6 carbon atoms, especially methyl, ethyl, i-propyl or n-propyl, the methacryloyloxyalkyl or acryloyloxyalkyl groups correspond preferably to a 3-methacryloyloxypropyl group and/or to a 3-acryloyloxypropyl group, the alkoxy group is preferably selected from the group of methoxy, ethoxy, n-propoxy and/or isopropoxy, the alkenyl group is preferably a vinyl, isoprenyl or allyl group, the epoxy group corresponds preferably to a 3-glycidyloxypropyl or 2-(3,4-epoxycyclohexyl)ethyl group, the haloalkyl group corresponds preferably to a fluoroalkyl group with a R⁸*—Yₘ—(CH₂)ₛ— radical where R⁸* corresponds to a mono-, oligo- or perfluorinated alkyl radical having 1 to 9 carbon atoms or to a mono-, oligo- or perfluorinated aryl radical, where Y is also a CH₂, O, aryl or S radical, and m=0 or 1 and s=0 or 2. In one embodiment, R¹ corresponds to a F₃C(CF₂)ᵣ(CH₂)ₛ group where r is an integer of 0 to 9, s is 0 or 2, r is preferably 5 and s is preferably 2; particularly preferred groups are the CF₃(CF₂)₅(CH₂)₂— or CF₃(CF₂)₇(CH₂)₂— or CF₃(C₆H₄)— or C₆F₅ groups.

With regards to the composition and to the structure of the oligomeric and/or polymeric organosilanes, reference is made to the above remarks.

The invention further provides for the use of an activated carbon, of a silicate, of an organic resin and/or of a zeolite for reducing the content of an organic polar compound and/or of at least one extraneous metal and/or of a compound containing at least one extraneous metal from compositions containing organosilanes of the general formula I and/or organosilanes which correspond to oligomeric or polymeric organosiloxanes which are obtained from the at least partial hydrolysis and condensation of organosilanes of the general formula I

R¹ₐR²_{b}R³_{c}Si(OR⁴)_{(4-a-b-c)} (I)

were 0≦a≦3, 0≦b≦3, 0≦c≦3 and a+b+c≦3, and the radicals correspond to the above-mentioned substitution patterns for the R¹, R², R³ and/or R⁴ radicals.

The invention is illustrated in detail by the examples which follow.

### EXAMPLES

### Example 1.1

### Pretreatment of the Adsorbent

All adsorbents are carefully predried before use in order to prevent hydrolysis of the silanes to be purified. The adsorbents are dried at 110° C. for 3 hours and stored in a desiccator over desiccants until use.

### Example 1.2

General process method for treatment of the organosilanes:

The organosilane to be purified is initially charged in a flask with stirrer and nitrogen connection under a nitrogen atmosphere, and a defined amount of the appropriate adsorbent is added. This mixture is then stirred at room temperature for two hours, and the adsorbent is subsequently removed through a pressure filter (Seitz Supradur 100 depth filter).

### Example 2.1

The example which follows was carried out according to the general process method under Example 1.2 with the amounts specified here.

Two samples each of 235 g of tetraethoxysilane with different contents of ethanol were treated with in each case 0.75 g of activated carbon. The ethanol content before and after the treatment was determined by FID-GC.

TABLE 2.1
Ethanol content before and after the treatment

| | Ethanol content | Ethanol content |
|---|---|---|
| Tetraethoxysilane | before the | after the |
| sample number | treatment [GC %] | treatment [GC %] |
| 1 | 0.0429 | 0.0081 |
| 2 | 0.0182 | 0.0028 |

### Example 2.2

The example which follows was carried out according to the general process method under Example 1.2 with the amounts specified here.

Two samples each of 235 g of tetraethoxysilane with different contents of ethanol were treated with in each case 0.75 g of Seitz Super kieselguhr. The ethanol content before and after the treatment was determined by FID-GC.

TABLE 2.2
Ethanol content before and after the treatment

| | Ethanol content | Ethanol content |
|---|---|---|
| Tetraethoxysilane | before the | after the |
| sample number | treatment [GC %] | treatment [GC %] |
| 1 | 0.0783 | 0.0045 |
| 2 | 0.0182 | 0.0040 |

### Example 2.3

The example which follows was carried out according to the general process method under Example 1.2 with the amounts specified here.

Two samples each of 235 g of tetraethoxysilane with different contents of ethanol were treated with in each case 0.75 g of kieselguhr (Süd Chemie). The ethanol content before and after the treatment was determined by FID-GC.

TABLE 2.3
Ethanol content before and after the treatment

| | Ethanol content | Ethanol content |
|---|---|---|
| Tetraethoxysilane | before the | after the |
| sample number | treatment [GC %] | treatment [GC %] |
| 1 | 0.0783 | 0.0042 |
| 2 | 0.0182 | 0.0024 |

### Example 2.4

The example which follows was carried out according to the general process method under Example 1.2 with the amounts specified here.

250 g of tetraethoxysilane with elevated extraneous metal contents were treated with 0.75 g of activated carbon. The extraneous metal contents before and after the treatment were determined by means of ICP-MS.

TABLE 2.4
Extraneous metal contents before and after the
treatment:

| | Content before | Content after |
|---|---|---|
| Metal | treatment | treatment |
| Aluminium | 600 μg/kg | 8 μg/kg |
| Boron | 48 μg/kg | 1.4 μg/kg |
| Iron | 2970 μg/kg | 9 μg/kg |

### Example 2.5

The example which follows was carried out according to the general process method under Example 1.2 with the amounts specified here.

250 g of tetraethoxysilane with elevated extraneous metal contents were treated with 0.75 g of kieselguhr. The extraneous metal contents before and after the treatment were determined by means of ICP-MS.

TABLE 2.5
Extraneous metal contents before and after the
treatment:

| | Content before | Content after |
|---|---|---|
| Metal | treatment | treatment |
| Aluminium | 50 μg/kg | 28 μg/kg |
| Boron | 48 μg/kg | 1.2 μg/kg |
| Iron | 450 μg/kg | 61 μg/kg |

### Example 2.6

The example which follows was carried out according to the general process method under Example 1.2 with the amounts specified here.

250 g of methyltriethoxysilane with elevated iron content were treated with 0.75 g of activated carbon. The iron content before and after the treatment was determined by means of ICP-MS.

TABLE 2.6
Iron content before and after the treatment:

| | Content before | Content after |
|---|---|---|
| Metal | treatment | treatment |
| Iron | 57 μg/kg | 3.1 μg/kg |

1. A process for treating a composition comprising organosilanes and at least one polar organic compound and/or at least one extraneous metal and/or a compound containing extraneous metal,
wherein
the composition is contacted with at least one adsorbent and a composition in which the content of the organic polar compound and/or of the extraneous metal and/or of the compound containing extraneous metal is reduced is obtained.

2. The process according to claim 1, wherein at least one organosilane corresponds to the general formula I
R¹ₐR²_{b}R³_{c}Si(OR⁴)_{(4-a-b-c)} (I)
in which 0≦a≦3, 0≦b≦3, 0≦c≦3 and a+b+c≦3, R¹ is hydrogen, a linear, branched and/or cyclic, optionally substituted alkyl group having 1 to 18 carbon atoms and/or a linear, branched and/or cyclic alkoxy, alkoxyalkyl, aryloxyalkyl, arylalkyl, aminoalkyl, haloalkyl, polyether, polyetheralkyl, alkenyl, alkynyl, epoxyalkyl, ureidoalkyl, mercaptoalkyl, cyanoalkyl, isocyanatoalkyl, methacryloyloxyalkyl and/or acryloyloxyalkyl group having 1 to 18 carbon atoms and/or an aryl group having 6 to 12 carbon atoms, in which R² is hydrogen, a linear, branched and/or cyclic alkyl group having 1 to 18 carbon atoms and/or an aryl group having 6 to 12 carbon atoms, R³ is hydrogen, a linear, branched and/or cyclic alkyl group having 1 to 18 carbon atoms and/or an aryl group having 6 to 12 carbon atoms, and/or R⁴ is a linear, branched and/or cyclic alkyl and/or alkoxyalkyl group having 1 to 8 carbon atoms, and/or mixtures of these organosilanes.

3. The process according to claim 1,
wherein
the composition is essentially anhydrous.

4. The process according to claim 1,
wherein
the organosilane is a tetraalkoxysilane, an alkyltrialkoxysilane, a dialklyldialkoxysilane and/or a trialkylalkoxysilane.

5. The process according to claim 1,
wherein
the organosilane is tetraethoxysilane, tetramethoxysilane, methyltriethoxysilane, methyltrimethoxysilane, dimethyldiethoxysilane and/or diethyldiethoxysilane.

6. The process according to claim 1,
wherein
the organosilane corresponds to oligomeric or polymeric organosiloxanes which are obtained from the at least partial hydrolysis and condensation of organosilanes of the general formula I
R¹ₐR²_{b}R³_{c}Si(OR⁴)_{(4-a-b-c)} (I)
in which 0≦a≦3, 0≦b≦3, 0≦c≦3 and a+b+c≦3, R¹ is hydrogen, a linear, branched and/or cyclic, optionally substituted alkyl group having 1 to 18 carbon atoms and/or a linear, branched and/or cyclic alkoxy, alkoxyalkyl, aryloxyalkyl, arylalkyl, aminoalkyl, haloalkyl, polyether, polyetheralkyl, alkenyl, alkynyl, epoxyalkyl, ureidoalkyl, mercaptoalkyl, cyanoalkyl, isocyanatoalkyl, methacryloyloxyalkyl and/or acryloyloxyalkyl group having 1 to 18 carbon atoms and/or an aryl group having 6 to 12 carbon atoms, in which R² is hydrogen, a linear, branched and/or cyclic alkyl group having 1 to 18 carbon atoms and/or an aryl group having 6 to 12 carbon atoms, R³ is hydrogen, a linear, branched and/or cyclic alkyl group having 1 to 18 carbon atoms and/or an aryl group having 6 to 12 carbon atoms, and/or R⁴ is a linear, branched and/or cyclic alkyl and/or alkoxyalkyl group having 1 to 8 carbon atoms, and/or mixtures of these organosilanes.

7. The process according to claim 1,
wherein
the compound containing extraneous metal is selected from metallic esters, metal halides, metal hydrides, metal alkoxides, metal halides substituted by organic radicals and/or metal hydrides substituted by organic radicals.

8. The process according to claim 1,
wherein
the boiling point of the polar organic compound and/or of the compound containing extraneous metal is in the range of the boiling point of an organosilane at standard pressure±20° C.

9. The process according to claim 1,
wherein
the content of the extraneous metal and/or of the compound containing extraneous metal is reduced by 40.0 to 99.8% by weight.

10. The process according to claim 1,
wherein
the extraneous metal content and/or the content of the compound containing extraneous metal is in each case reduced to below 100 μg/kg.

11. The process according to claim 1,
wherein
the polar organic compound is an alcohol.

12. The process according to claim 1,
wherein
the polar organic compound is an alcohol selected from the group consisting of ethanol, methanol, butanol, n-propanol and/or isopropanol.

13. The process according to claim 1,
wherein
the polar organic compound is lowered to a content of below 0.01% by weight.

14. The process according to claim 1,
wherein
the adsorbent is hydrophilic and/or hydrophobic.

15. The process according to claim 1,
wherein
the adsorbent is selected from the group consisting of the activated carbons, silicates, organic resins and/or zeolites.

16. The process according to claim 1,
wherein
it is performed continuously or batchwise.

17. A composition containing at least one organosilane of the general formula I and/or organosilanes which corresponds to oligomeric or polymeric organosiloxanes which are obtained from the at least partial hydrolysis and condensation of organosilanes of the general formula I
R¹ₐR²_{b}R³_{c}Si(OR⁴)_{(4-a-b-c)} (I)
in which 0≦a≦3, 0≦b≦3, 0≦c≦3 and a+b+c≦3, R¹ is hydrogen, a linear, branched and/or cyclic, optionally substituted alkyl group having 1 to 18 carbon atoms and/or a linear, branched and/or cyclic alkoxy, alkoxyalkyl, aryloxyalkyl, arylalkyl, aminoalkyl, haloalkyl, polyether, polyetheralkyl, alkenyl, alkynyl, epoxyalkyl, ureidoalkyl, mercaptoalkyl, cyanoalkyl, isocyanatoalkyl, methacryloyloxyalkyl and/or acryloyloxyalkyl group having 1 to 18 carbon atoms and/or an aryl group having 6 to 12 carbon atoms, in which R² is hydrogen, a linear, branched and/or cyclic alkyl group having 1 to 18 carbon atoms and/or an aryl group having 6 to 12 carbon atoms, R³ is hydrogen, a linear, branched and/or cyclic alkyl group having 1 to 18 carbon atoms and/or an aryl group having 6 to 12 carbon atoms, and/or R⁴ is a linear, branched and/or cyclic alkyl and/or alkoxyalkyl group having 1 to 8 carbon atoms, and/or mixtures of these organosilanes, whose extraneous metal content and/or content of the compound containing extraneous metal is in each case below 100 μg/kg and/or whose residual content of organic polar compounds is below 0.01% by weight.

18. The composition according to claim 17,
wherein
it is essentially anhydrous.

19. The composition according to claim 17,
wherein
the polar organic compound is an alcohol selected from the group consisting of ethanol, methanol, butanol, n-propanol and/or isopropanol.

20. A method for reducing the content of an organic polar compound and/or of at least one extraneous metal and/or of at least one compound containing extraneous metal from compositions containing organosilanes according to claim 17 comprising using an organic resin, an activated carbon, a silicate and/or a zeolite.
